(19) United States
(12) Patent Application Publication
(10) Pub. No.: US 2002/0144271 A1
(43) Pub. Date: Oct. 3, 2002

(54) DEVICE FOR REMOTE CONTROL OF A COMPUTER BY RADIO

(76) Inventors: MICHAEL BEHAGEN, TEL AVIV (IL); IRA DVIR, TEL AVIV (IL)

Correspondence Address: G.E. EHRLICH (1995) LTD., c/o ANTHONY CASTORINA, 2001 JEFFERSON DAVIS HIGHWAY, SUITE 207, ARLINGTON, VA, 22202, US

(21) Appl. No.: 09/197,441

(22) Filed: Nov. 23, 1998

(51) Int. Cl. H04N 7/173; H04N 7/18; H04N 7/16; G06F 15/16; H04N 7/00; H04N 11/00

(52) U.S. Cl. 725/74; 725/141; 709/227; 348/552

(57) ABSTRACT

A device for remotely displaying information from a monitor of a main computer and for remotely and fully controlling the main computer. The device of the present invention includes a remote A/V display device and a remote input platform. The remote input platform has a radio transmitter and the remote A/V display device has a radio receiver for communicating with the main computer, which is in communication with a corresponding radio transmitter and a corresponding radio receiver. The main computer sends audio and video signals through the radio transmitter for displaying information, preferably in the form of a GUI (graphical user interface), on the remote A/V display device. Preferably, the information also includes streaming video and/or graphics, as well as screaming sound. Similarly, the main computer receives input instructions by the radio receiver from the user through the remote input platform. Only the main computer has a CPU, although either or both of the remote A/V display device and the remote input platform may have a microprocessor or other processor. Thus, the portions of the computer with which the user directly interacts, the A/V display device and the input platform, can be remote devices, potentially physically separated from the main portion of the main computer (including the CPU).

### FIELD AND BACKGROUND OF THE INVENTION

The present invention relates to a non-network device for direct remote control of a main computer, and in particular, to a system in which the non-network device features a remote monitor and speakers which directly display the visual and audio display of the main computer and in which the device features a remote input platform for sending instructions directly to the main computer.

Computers are becoming more popular as home entertainment devices and for the organization and display of information for the consumer. In addition, to the functions of earlier computers, computers today can play music stored in a variety of formats, including files stored in the MP3 format on a CD, on magnetic storage medium or on the DVD storage medium, as well as displaying video streams and enabling “chats” to take place through the Internet. In addition, consumers can now perform a variety of tasks “on-line” through the computer, such as order groceries from the local supermarket, which are then delivered to the house of the consumer. These applications have the advantage of being more efficient and of saving the consumer time.

The computer itself has been sufficiently adapted for the household environment and for the new multi-media tasks, except for portability. The typical household computer is a “desktop” computer which is not very portable. However, certain applications such as playing and managing a musical database or otherwise interacting with the computer from a remote location would be more efficient if the computer could easily be moved from room to room. Thus, desktop computers are not sufficiently portable for such tasks.

A more useful solution would enable the consumer to view the display of the monitor of the computer and to interact with the computer anywhere in the house, as a remote application. The entire computer would not need to be moved about from room to room, but only those portions which are required for controlling the computer and for displaying information on the monitor Unfortunately, those remote computing solutions which are available only enable partial control, and do not permit portions of the computer to be operated in a fully remote and independent fashion, while still remaining tied to the CPU of the computer but without an additional network connection.

Therefore, there is an unmet need for, and it would be highly useful to have, a device for remote display of information on a monitor and for remotely controlling a computer, as though the user was in physical proximity to computer.

### SUMMARY OF THE INVENTION

The present invention is of a device for remotely displaying the audiovisual information of a main computer and for remotely and fully controlling the functions of the main computer. The device of the present invention includes a remote A/V (audiovisual) display device and a remote input platform. The remote input platform has a radio transmitter and the remote A/V display device has a radio receiver for communicating with the main computer, which is in communication with the corresponding radio transmitter and radio receiver. The main computer sends audiovideo signals through the radio transmitter for displaying information, preferably in the film of a GUI (graphical user interface), on the remote A/V display device. Preferably, the information also includes streaming video and/or graphics. Similarly the main computer receives input instructions by the radio receiver from the user through the remote input platform. Only the main computer has a CPU, although either or both of the remote A/V display device and the remote input platform may have a microprocessor or other processor. Thus, the portions of the computer with which the user directly interacts, the display device and the input platform, can be remote devices, potentially physically separated from the main portion of the main computer (including the CPU).

According to the present invention, there is provided a remote display device for remote interaction by a user with a main computer, the main computer being in communication with a main transmitter and a main receiver, the main computer featuring a local video card and the main computer featuring a local input port for receiving input instructions, the device comprising: (a) a remote display device for receiving display signals directly from the local video card through the main transmitter and for displaying a display to the user, the display being at least a visual display, the remote display device featuring a remote receiver for receiving the display signals, and (b) a remote input platform for receiving input data from the user and for transmitting the input data directly to the local input port of the mum computer through the main receiver, the remote input platform featuring a remote transmitter for transmitting the input data to the main receiver; such that the device lacks a CPU (central processing unit) and such that only the main computer has the CPU.

According to another embodiment of the present invention, there is provided a system for remote interaction with a user, comprising (a) a main computer, the main computer featuring a CPU, the main computer comprising: (i) a main radio transmitter for transmitting radiowaves and a mail, receiver for receiving radiowaves; (ii) a plurality of video cards, including at least a first video card being locally connectable: and (iii) an operating system capable of controlling the plurality of video cards substantially simultaneously; (b) a remote display device for receiving display signals from a second of the plurality of video cards through the main transmitter of the main computer and for displaying a visual display to the user, the remote display device featuring a remote radiowave receiver for receiving the display signals, the remote display device lacking a CPU; and (c) a remote input platform for receiving input data from the user and for transmitting the input data to the main computer the remote input platform featuring a remote radiowave transmitter for transmitting the input data, the remote input platform lacking a CPU.

Hereinafter, the term “computing platform” refers to a particular computer hardware system or to a particular software operating system. Examples of such hardware systems include, but are not limited to, personal computers (PC), palmtops, handheld computers, Macintosh™ computers, mainframes, minicomputers and workstations. Examples of such software operating systems include, but are not limited to, UNIX, VMS, Linux, MacOS™, DOS, are of the Windows™ operating systems by Microsoft Inc. (Seattle, Wash. USA), including Windows NT™, Windows 3x™ (in which “x” is a version number, such as “Windows 3.1”), Windows CE™, Windows95™, and Windows98™, as well as any suitable operating system for embedded units or palmtop/handheld type computers.

For the present invention, a software application could be written in substantially any suitable programming language, which could easily be selected by one of ordinary skill in the art. The programming language chosen should be compatible with the computing platform according to which the software application is executed. Examples of suitable programming languages include, but are not limited to, C, C−+ and Java.

In addition, the present invention could be implemented as software, firmware or hardware, or as a combination thereof. For any of these implementations, the functional steps performed by the method could be described as a plurality of instructions performed by a data processor.

Hereinafter, the term “CPU” (central processing unit) includes those portions of the computer which control the remainder of the computer, including the peripherals. As defined herein, the CPU includes the control unit and the arithmetic and logic unit (ALU), as well as other components such as memory and temporary buffers which are required for the operation of the control unit and the ALU. Other types of microprocessors or data processors are specifically excluded from the term “CPU” as herein defined.

Hereinafter, the term “speaker” is defined to include any type of device for producing an audible sound stream for a user, including an earphone.

Hereinafter, a “locally connectable” video card is a video card which is capable of controlling a monitor or other display device which is attached to the computer in which the video card is located regardless of whether the computer actually has such a monitor or other display device attached.

### BRIEF DESCRIPTION OF THE DRAWINGS

The invention is herein described, by way of example only, with reference to the accompanying drawings, wherein.

FIG. 1 is a schematic block diagram illustrating an exemplary device and system according to the present invention.

### DESCRIPTION OF THE PREFERRED EMBODIMENTS

The present invention is of a device for remotely displaying information from a monitor of a main computer and for remotely and fully controlling the main computer. The device of the present invention includes a remote A/V display device and a remote input platform. The remote input platform has a radio transmitter and the remote A/V display device has a radio receiver for communicating with the main computer, which is in communication with a corresponding radio transmitter and a corresponding radio receiver. The main computer sends audio and video signals through the radio transmitter for displaying information, preferably in the form of a GUI(graphical user interface), on the remote A/V display device.

Preferably, the information also includes streaming video and/or graphics, as well as streaming sound.

Similarly, the main computer receives input instructions by the radio receiver from the user through the remote input platform. Only the main computer has a CPU, although either or both of the remote A/V display device and the remote input platform may have a microprocessor or orther processor. Thus, the portions of the computer with which the user directly interacts, the A/V display device and the input platform, can be remote devices, potentially physically separated from the main portion of the main computer (including the CPU).

The principles and operation of the device according to the present invention may be better understood with reference to the drawings and the accompanying description.

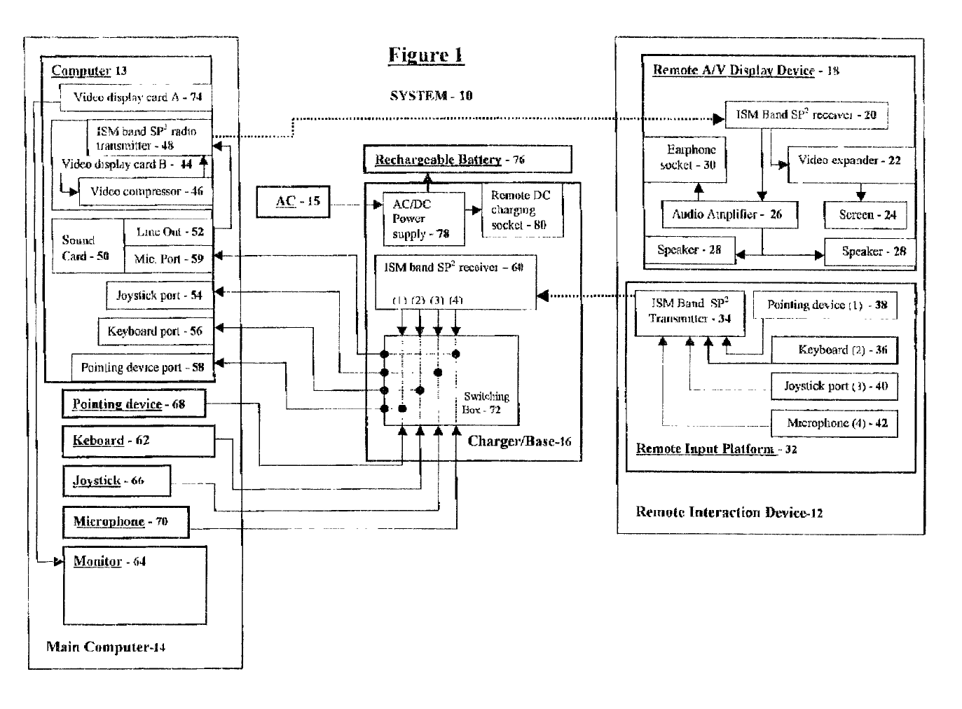

Referring now to the drawings, FIG. 1 is a schematic block diagram illustrating an exemplary device and system according to the present invention. A system 10 includes a remote interaction device 12 for interaction with the user of a main computer 14. Remote interaction device 12 is preferably able to communicate with main computer 14 through radiowave communication. Preferably, remote interaction device 12 receives power through a battery which is optionally chargeable at a charger/base 16.

Remote interaction device 12 features a remote A/V display device 18 display device 18 could optionally display only audio or only visual data. Hereinafter, the term “display” can include both a visual and an audio display. Remote A/V display device 18 preferably includes an ISM band receiver 20 for receiving communication from main computer 14. More preferably, all of the radiowave receivers and transmitters of the present invention operate as low-frequency radiowaves, most preferably in the range of from about 2.4 GHz to about 5.8 GHz, as this range does not require a special license in the United States of America In addition, remote A/V display device 18 preferably also features a video expander 22 for expanding the compressed video signals for display on a screen 24. The type of video expander 22 and the type of screen 24 would depend upon the type of remote A/V display device 18 and could easily be selected by one of ordinary skill in the art. Examples of screen 24 include but are not limited to any type of flat screen including a plasma screen or an LCD (liquid crystal display), a CRT (cathode ray tube) monitor, a computer monitor or any other type of video display monitor. Thus, remote A/V display device 18 enables visual data such as a GUI (graphical user interface), other graphics or images, or a video stream, to be displayed to the user.

Optionally and preferably, remote A/V display device 18 includes an audio amplifier 26 and at least one, but preferably two speakers 28 as shown Also optionally and preferably, remote A/V display device 18 features earphones 30. The audio data is received by ISM band receiver 20 which is also connected to audio amplifier 26. Audio amplifier 26 then renders the audio data into an audio stream for an audio display to the user Thus, these preferred components enable remote A/V display device 18 to play music or to otherwise render an audio stream audible to the user

In addition, remote interaction device 12 also features a remote input platform 32. Remote input platform 32 enables information and instructions to be entered by the user. Remote input platform 32 includes an ISM band SP² transmitter 34 for transmitting radiowaves to main computer 14 in order to communicate the information and instructions from the user. As shown, remote input platform 32 optionally and preferably includes a number of different input components for accepting input from the user. For example, remote input platform 32 optionally and preferably includes a keyboard 36 for entering textual or other character-based input.

Remote input platform 32 optionally and preferably also includes a pointing device 38 such as a mouse, trackball, touchpad, touch-sensitive screen or other pointing device, in order for the user to be able to select a command or other input from the GUI preferably displayed by remote A/V display device 18. Keyboard 36 and pointing device 38 are particularly preferred because these two input devices are typical of most home computers and as such are familiar to the user. Thus, remote A/V display device 18 and remote input platform 32 could be one physical unit or else two physically separated components.

In addition, remote input platform 32 also optionally and preferably includes a joystick port 40, for example for receiving a joystick for playing electronic games. Remote input platform 32 also optionally and preferably includes a microphone 42 for receiving voice-based instructions or for recording the voice of the user on main computer 14, for example.

Thus, remote input platform 32 enables the user to input data, such as information and commands, which are then transmitted by radiowaves through ISM band SP² transmitter 34 to main computer 14. Main computer 14 then sends signals for video display to remote A/V display device 18, which receives these signals through ISM band receiver 20. The components of main computer 14 which enable main computer 14 to both control the display on remote A/V display device 18 and to respond to data input through remote input platform 32 are as follows.

Main computer 14 preferably includes a video display card 44 which is connected to an A/V compressor 46 for compressing the video data, both of which are preferably located within a main computer box 13. Main computer 14 sends display instructions for displaying video information on remote A/V display device 18 to video display card 44. Video display card 44 then renders the instructions as video display signals suitable for a monitor such as screen 24. The signals are then compressed by A/V compressor 46. After compression, the signals are sent as radiowaves by an ISM band SP² transmitter 48. The transmitted radiowaves are then received by ISM band receiver 20, expanded by video expander 22 and displayed by screen 24 as previously described.

Optionally, main computer 14 could include a sound card 50 for receiving display signals for “displaying” (making audible) audio information on remote A/V display device 18. Sound card 50 would then render these display signals into audio signals suitable for audio amplifier 26. The audio signals would then be passed to ISM band SP² transmitter 48 through a “line out” port 52 on sound card 50.

Main computer 14 also includes a joystick port 54 for receiving input from a joystick; a keyboard port 56 for receiving input from a keyboard such as remote keyboard 36; and a pointing device port 58 for receiving input from a pointing device such as pointing device 38. In addition, sound card 50 preferably includes a “line-in” or microphone port 59. All of these ports receive input through an ISM band receiver 60 as shown, which could be located in charger/base 16 or alternatively could be located at main computer 14.

Optionally and preferably, all of these ports also receive input from peripheral devices directly physically attached to main computer 14. Therefore, main computer 14 preferably also includes a keyboard 62, a monitor 64, a joystick 66, a pointing device 68 and a microphone 70 which are local peripheral devices. Thus, these local peripheral devices enable the user to operate main computer 14 locally.

In order for main computer 14 to be able to receive input data from both sets of peripheral devices, those attached locally such as keyboard 62, and those in remote communication such as remote input platform 32, preferably charger/base 16 also features a switching box 72. Preferably, ISM band receiver 60 is also located at charger/base 16. Switching box 72 receives the input data from ISM band receiver 60, and then sends this data to the correct port on main computer 14, such as keyboard port 56, for example. Conversely, when input data is being received from a local peripheral device, such as keyboard 62 for example, switching box 72 then sends this input data to the correct port on main computer 14, in this case keyboard port 56. Thus, switching box 72 enables both local and remote peripherals to sequentially access main computer 14.

In addition, in order for two different monitors to be controlled by main computer 14, including both local monitor 64 and remote A/V display device 18, preferably main computer 14 also features a second video display card 74. Second video display card 74 receives instructions from main computer 14 for displaying video information, such as a GUI, on local monitor 64. However, in order to accommodate this preferred embodiment of the present invention, main computer 14 must be operated by an operating system which is capable of controlling two monitors by controlling two video cards. An example of such an operating system is Windows 98™.

As its name implies, charger/base 16 also preferably features components for supplying power to remote A/V display device 18 and to remote input platform 32. Preferably, power is supplied to both remote A/V display device 18 and remote input platform 32 through a rechargeable batter 76, although each of remote A/V display device 18 and remote input platform 32 could have a separate battery power source. Charger/base 16 therefore preferably recharges rechargeable battery 76, through an AC/DC power supply 78 and a remote DC charging socket 80. AC/DC power supply 78 receives power from an AC supply 15. Optionally and preferably, a remote charging plug (not shown) is located at remote interaction device 12 for connecting to remote DC charging socket 80 or to an external DC source (not shown). Thus, when battery-operated, remote A/V display device 18 and remote input platform 32 are preferably completely portable, such that neither requires a direct wire connection to an electrical socket.

Therefore, the device of the present invention provides complete interactivity with a main computer at a remote location, without requiring a network card and without a physical wire or cable connection. The interactivity is provided through a remote A/V display device and a remote input platform, both of which lack a CPU. Thus, the main computer controls the actions of the remote A/V display device according to instructions received from the remote input platform.

While the invention has been described with respect to a limited number of embodiments, it will be appreciated that many variations, modifications and other applications of the invention may be made.

What is claimed is:

1. A remote display device for remote interaction by a user with a main computer, the main computer being in communication with a main transmitter and a main receiver, the main computer featuring a local video card and the main computer featuring a local input port for receiving input instructions, the device comprising:
(a) a remote display device for receiving display signals directly from the local video card through the main transmitter and for displaying a display to the user, said remote display device featuring a remote receiver for receiving said display signals; and
(b) a remote input platform for receiving input data from the user and for transmitting said input data directly to the local input port of the main computer through the main receiver, said remote input platform featuring a remote transmitter for transmitting said input data to the main receiver;
such that the device lacks a CPU (central processing unit) and such that only the main computer has said CPU.

2. The device of claim 1, wherein said remote receiver and the main receiver are loot radiowave receivers.

3. The device of claim 2, wherein said radiowave receiver receives radiowaves in a range of from about 2.4 GHz to about 5.8 GHz.

4. The device of claim 3, wherein said radiowave receiver is an ISM band receiver.

5. The device of claim 1, wherein said remote transmitter and the main transmitter are both radiowave transmitters.

6. The device of claim 5, wherein said radiowave transmitter transmits radiowaves in a range of from about 2.4 GHz to about 5.8 GHz.

7. The device of claim 6, wherein said radiowave transmitter is an ISM band SP² transmitter.

8. The device of claim 1, wherein said display is at least a visual display, and wherein said remote display device further comprises:
(i) a video expander for receiving said display signals from said remote receiver and for expanding said display signals to produce expanded signals; and
(ii) a screen for displaying said display signals according to said expanded signals from said video expander.

9. The device of claim 8, wherein said screen is selected from the group consisting of a plasma screen, a LCD (liquid crystal display) screen and a CRT (cathode ray tube) screen.

10. The device of claim 8, wherein said display is at least an audio display and said remote display device further comprises:
(iii) an audio amplifier for amplifying audio signals from said remote receiver; and
(iv) a speaker for audibly displaying said audio display to the user according to said audio signals received from said audio amplifier.

11. The device of claim 1, wherein said remote input platform further comprises a remote keyboard and a remote pointing device.

12. The device of claim 11, wherein said remote input platform further comprises a joystick port.

13. The device of claim 12, wherein said remote input platform further comprises a microphone.

14. A system for remote interaction with a user, comprising:
(a) a main computer, said main computer featuring a CPU, said main computer comprising:
(i) a main radio transmitter for transmitting radiowaves and a main receiver for receiving radiowaves;
(ii) a plurality of video cards, including at least a first video card being locally connectable; and
(iii) an operating system capable of controlling said plurality of video cards substantially simultaneously;
(b) a remote display device for receiving display signals from a second of said plurality of video cards through said main transmitter of said main computer and for displaying a visual display to the user, said remote display device featuring a remote radiowave receiver for receiving said display signals, said remote display device lacking a CPU; and
(c) a remote input platform for receiving input data from the user and for transmitting said input data to said main computer, said remote input platform featuring a remote radiowave transmitter for transmitting said input data, said remote input platform lacking a CPU.

15. The system of claim 14, wherein said main computer further comprises:
(iv) a local input device; and
(v) an input device port for receiving input data from said local input device and from said remote input platform;
and wherein the system further comprises:
(d) a switching box for switching said input data from said local input device and from said remote input platform to said input device port.

16. The system of claim 15, wherein said main computer features a main radiowave receiver for receiving radiowaves from said remote input platform.

17. The system of claim 15 wherein said switching box features a main radiowave receiver for receiving radiowaves from said remote input platform, said switching box passing said radiowaves to said main computer.
